(19) United States
(12) Patent Application Publication
(10) Pub. No.: US 2018/0134178 A1
(43) Pub. Date: May 17, 2018

(54) FUEL CELL SYSTEM AND UNDER HOOD STRUCTURE OF VEHICLE

(71) Applicant: TOYOTA JIDOSHA KABUSHIKI KAISHA, Toyota-shi (JP)

(72) Inventors: Masahiro KATAYAMA, Seto-shi (JP); Yuma TAKABATAKE, Toyota-shi (JP)

(73) Assignee: TOYOTA JIDOSHA KABUSHIKI KAISHA, Toyota-shi (JP)

(21) Appl. No.: 15/802,818

(22) Filed: Nov. 3, 2017

(30) Foreign Application Priority Data
Nov. 16, 2016 (JP) 2016-223211

(51) Int. Cl. B60L 11/18; B60K 1/04; H01M 8/02

(52) U.S. Cl. CPC B60L 11/1896; H01M 8/22; H01M 8/02; B60K 1/04

(57) ABSTRACT

Provided is a fuel cell system which includes a fuel cell that generates electric power by electrochemical reaction between hydrogen gas and oxidizing gas, and a fuel cell case that houses the fuel cell. A more fragile portion compared to the rest of the fuel cell case in terms of strength is provided in the fuel cell case along an outline of a given shape so that a depressurizing opening having the given shape is formed when internal pressure of the fuel cell case becomes higher than given pressure.

### INCORPORATION BY REFERENCE

The disclosure of Japanese Patent Application No. 2016-223211 filed on Nov. 16, 2016 including the specification, drawings and abstract is incorporated herein by reference in its entirety.

### BACKGROUND

### 1. Technical Field

The disclosure relates to a fuel cell system and an under hood structure of a vehicle.

### 2. Description of Related Art

A fuel cell system is known, which includes a fuel cell that generates electric power by electrochemical reaction between hydrogen gas, serving as anode gas, and oxidizing gas, serving as cathode gas. In a fuel cell system for car and so on, it is necessary to prevent a fuel cell from being exposed to foreign matters such as dust and to water, and to prevent hands from mistakenly touching the fuel cell during maintenance and so on. Japanese Patent Application Publication No. 2016-096064 (JP 2016-096064 A) describes a fuel cell system further including a case that houses a fuel cell inside.

### SUMMARY

In the fuel cell system described in JP 2016-096064 A, at the time of occurrence of abnormality such as collision, in a case where hydrogen leaking from the fuel cell burns and pressure in the case that houses the fuel cell increases, an unintended portion of the case could be broken. Here, the unintended portion of the case includes, for example, a portion where the fuel cell should not be exposed to outside so as to ensure safety during maintenance, and a portion where scattering of broken pieces caused by breakage of the case should be avoided.

In order to prevent breakage of the unintended portion of the case as stated above, it is considered to form a sufficiently large depressurizing opening in advance in a specific portion of the case. However, when such a sufficiently large depressurizing opening is formed in advance in a case of a fuel cell system mounted on a vehicle, problems such as insufficient strength of the case happen, resulting in easy breakage of the case due to vibration while a vehicle is running.

The disclosure provides a fuel cell system and an under hood structure of a vehicle that are able to prevent an unintended portion of a case housing a fuel cell from being broken due to hydrogen combustion when abnormality occurs, without losing durability.

The first aspect of the disclosure relates to a fuel cell system including a fuel cell that generates electric power by electrochemical reaction between hydrogen gas and oxidizing gas, and a case that houses the fuel cell. A more fragile portion compared to a portion of the case other than the more fragile portion in terms of strength is provided in a specific surface of the case along an outline of a given shape so that a depressurizing opening having the given shape is formed when internal pressure of the case becomes higher than given pressure. When internal pressure of the case becomes higher than given pressure, a crack(s) is made on a line connecting the fragile portion and the crack(s) on the line becomes a single connected cutout. Thus, the depressurizing opening having the given shape is formed in the specific surface of the case, making it possible to prevent an unintended portion from being broken due to hydrogen combustion at the time of occurrence of abnormality. Further, in the specific surface of the case, it is only necessary to provide the fragile portion whose total area is much smaller than that of the depressurizing opening. Therefore, strength of the fuel cell case does not decrease drastically. Thus, durability of the case against vibration and so on while a vehicle is running is not deteriorated.

Further, among surfaces of the case, the specific surface may be a surface adjacent to an object arranged outside the case. When the fragile portion is provided in the specific surface, the depressurizing opening having the given shape is formed in the specific surface when internal pressure of the case becomes higher than given pressure. Since an object arranged outside the case is adjacent to the specific surface, it is hard for a human hand to reach the specific surface. Therefore, even when the depressurizing opening having the given shape is formed in the specific surface, a risk of a hand mistakenly being in contact with the fuel cell, which is a high voltage component, is extremely low, and it is thus possible to ensure safety sufficiently.

Further, the fragile portion may be formed in the specific surface of the case along three sides of a rectangular shape so that the depressurizing opening having the rectangular shape is formed when internal pressure of the case becomes higher than the given pressure. In the case where the given shape of the depressurizing opening to be formed in the specific surface of the case is the rectangular shape, and the fragile portion is formed along the three sides of the rectangular shape, a probability is higher for a crack to be precisely made along the line that connects the fragile portion when internal pressure of the case becomes higher than given pressure. This means that, in the case where the fragile portion is formed in the specific surface of the case along the three sides of the rectangular shape, it is possible to form the depressurizing opening at a position and in a shape (the rectangular shape) as designed when internal pressure of the case becomes higher than given pressure.

The second aspect of the disclosure relates to an under hood structure of a vehicle, which includes a fuel cell that generates electric power by electrochemical reaction between hydrogen gas and oxidizing gas, a case that houses the fuel cell, and an object that is arranged outside the case and adjacent to a specific surface of the case. A more fragile portion compared to a portion of the case other than the more fragile portion in terms of strength is provided in the specific surface of the case along an outline of a given shape so that a depressurizing opening having the given shape is formed when internal pressure of the case becomes higher than given pressure.

According to the disclosure, it is possible to prevent an unintended portion of the case that houses the fuel cell from being broken due to hydrogen combustion at the time of occurrence of abnormality, without deteriorating durability.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a schematic view of an example of a state where a fuel cell system of the embodiment is arranged in an engine hood of a vehicle;

FIG. 2 is a view on arrow, seen from arrow A in FIG. 1;

FIG. 3 is a perspective view of an external appearance of a fuel cell case according to the embodiment;

FIG. 4 is a schematic view explaining how a depressurizing opening having a rectangular shape as a given shape is formed in a lower surface, which serves as a specific surface, of the fuel cell case shown in FIG. 3 when internal pressure of the fuel cell case increases and becomes higher than given pressure; and

FIG. 5 is a schematic view of a state where the depressurizing opening having the rectangular shape as the given shape is formed in the lower surface, which serves as the specific surface, of the fuel cell case shown in FIG. 3.

### DETAILED DESCRIPTION OF EMBODIMENTS

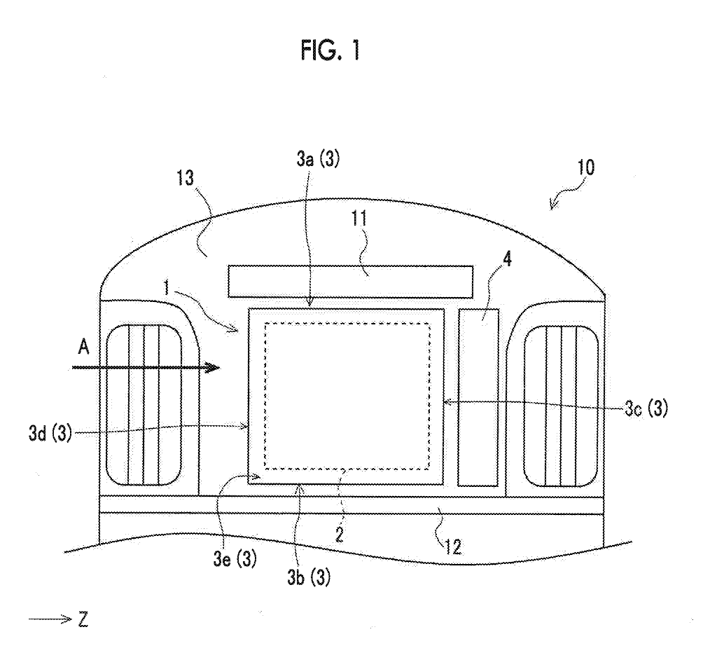

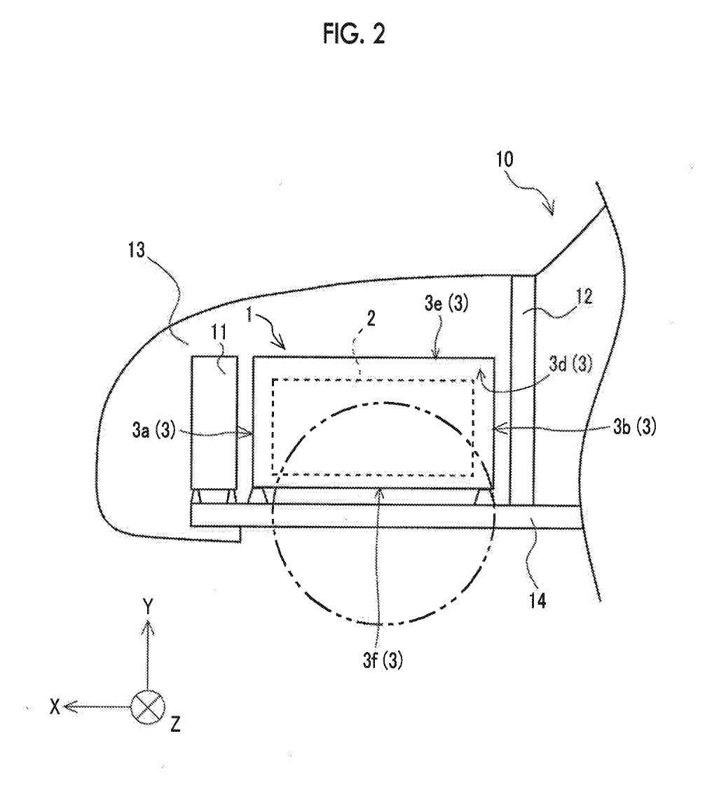

Hereinafter, the first embodiment of the disclosure is explained with reference to the drawings. First of all, a configuration of a fuel cell system 1 according to the embodiment is explained with reference to FIG. 1. FIG. 1 is a schematic view of an example of a state where the fuel cell system 1 according to the embodiment is arranged under an engine hood 13 of a vehicle 10. FIG. 2 is a view on arrow, seen from arrow A in FIG. 1. Here, the positive direction of X-axis shows a front side of the vehicle 10, the positive direction of Y-axis shows an upper side of the vehicle 10, and the positive direction of Z-axis shows the right side of the vehicle 10. As shown in FIG. 1 and FIG. 2, the fuel cell system 1 includes a fuel cell 2 and a fuel cell case 3.

The fuel cell 2 generates electric power by electrochemical reaction between hydrogen gas serving as cathode gas and oxidizing gas (air) serving as anode gas. The fuel cell 2 is structured by laminating single cells.

The fuel cell case 3 houses the fuel cell 2 inside. The fuel cell case 3 is, for example, a housing made of six surfaces, which are a front surface 3a, a rear surface 3b, a right surface 3c, a left surface 3d, an upper surface 3e, and a lower surface 3f. The fuel cell case 3 is made of, for example, a metallic material, or a resin material such as ABS resin. The metallic material is, for example, iron alloy and aluminum alloy, whose surface is coated with rubber material, synthetic resin material, and so on having insulating properties. Under the engine hood 13 of the vehicle 10, the fuel cell case 3 is arranged and fixed onto a frame 14 by bolts or the like so that the front surface 3a faces the positive direction of X-axis, the upper surface 3e faces the positive direction of Y-axis, and the right surface 3c faces the positive direction of Z-axis.

In an arrangement example of the fuel cell system 1 under the engine hood 13 of the vehicle 10 shown in FIG. 1 and FIG. 2, the front surface 3a of the fuel cell case 3 is adjacent to a radiator 11, the rear surface 3b is adjacent to a cabin forming member 12, the right surface 3c is adjacent to an accessory part 4, and the lower surface 3f is adjacent to the frame 14. This means that, among the surfaces of the fuel cell case 3, the front surface 3a, the rear surface 3b, the right surface 3c, and the lower surface 3f are adjacent to objects arranged outside the fuel cell case 3. Here, the accessory part 4 means a component, such as an air compressor, and a hydrogen pump, a power control unit (PCU), which is necessary to operate the fuel cell. On the contrary, no object is adjacent to the left surface 3d and the upper surface 3e of the fuel cell case 3. Here, “being adjacent” means that the surface of the fuel cell case 3 and the object are close to one another through a space that is too narrow for a human hand to get through (a space of about 0.5 mm to 50 mm).

It is hard for a human hand to reach the surfaces of the fuel cell case 3, which are adjacent to the objects arranged outside the fuel cell case 3. Even when a depressurizing opening having a given shape is formed on such a surface that is hard to reach with a human hand, a possibility of a hand mistakenly touching the fuel cell, which is a high voltage component, at the time of maintenance and so on is low. Therefore, it is preferred that one of the surfaces adjacent to the objects arranged outside the fuel cell case 3 is set as a specific surface where a depressurizing opening having a given shape should be formed when internal pressure of the fuel cell case 3 becomes higher than given pressure. The given pressure is decided based on experiment results and simulation results regarding internal pressure increase of the fuel cell case 3 when hydrogen leaking from the fuel cell 2 burns. The given pressure is set to a value of, for example, 0.2 MPa or higher.

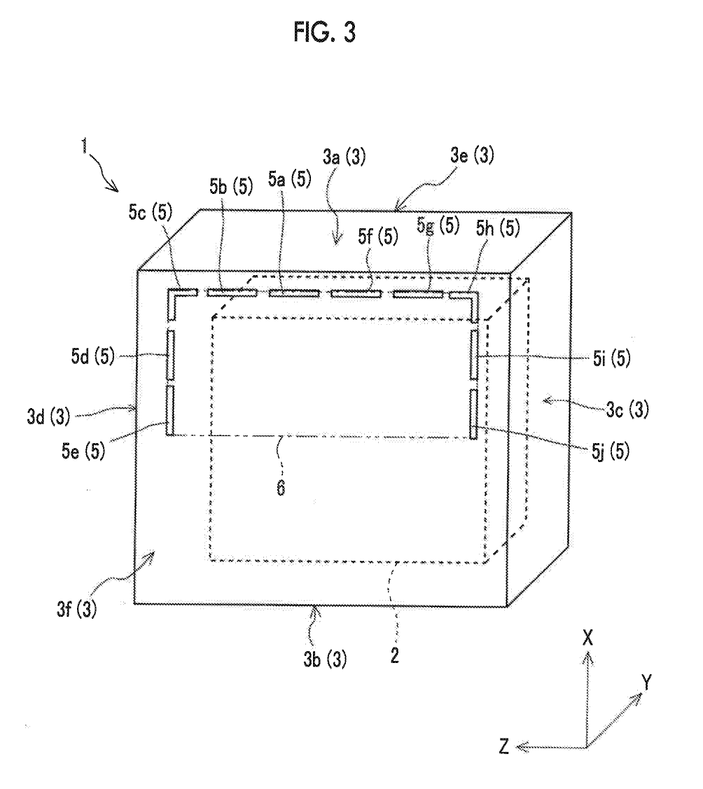

FIG. 3 is a perspective view of an external appearance of the fuel cell case 3. Here, the lower surface 3f is set as the specific surface where a depressurizing opening 6 having the given shape should be formed. Further, the given shape of the depressurizing opening 6 is set to be a rectangular shape. As shown in FIG. 3, in the lower surface 3f serving as the specific surface, a fragile portion 5 (5a, 5b, 5c, 5d, 5e, 5f, 5g, 5h, 5i, 5j) is provided along an outline of the given shape of the depressurizing opening 6 to be formed. This means that, in the lower surface 3f serving as the specific surface, the plurality of fragile portions 5a, 5b, 5c, 5d, 5e, 5f, 5g, 5h, 5i, 5j are provided in line along three sides of the rectangular shape that is the given shape of the depressurizing opening 6 to be formed.

Here, the fragile portion 5 is more fragile compared to the rest of the fuel cell case 3 in terms of strength, and, to be specific, the fragile portion 5 is a hole or a depressed part having a smaller thickness than the rest of the parts. In the case where the fragile portion 5 is a hole, it is necessary to close the hole with a thin film made of fire-resistive and weather-resistant resin ii order to prevent foreign matters such as dust, and water from entering the fuel cell case 3. In the case where the fragile portion 5 is a depressed part, it is not necessary to separate the fragile portion 5 into the plurality of parts (the fragile portions 5a, 5b, 5c, 5d, 5e, 5f, 5g, 5h, 5i, 5j) as shown in FIG. 3, and the single fragile portion 5 may be made. This means that, in the case where the fragile portion 5 is a depressed part, the single fragile portion 5 may be provided in the specific surface, extending continuously along the outline of the given shape of the depressurizing opening to be formed.

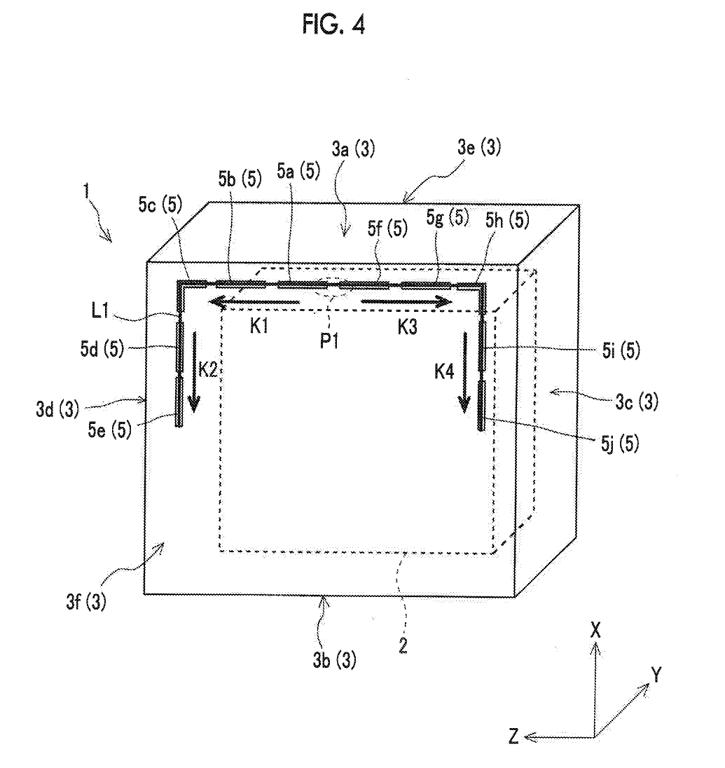

FIG. 4 is a schematic view explaining how the depressurizing opening 6 having the rectangular shape as the given shape is formed in the lower surface 3f that serves as the specific surface, when internal pressure of the fuel cell case 3 shown in FIG. 3 becomes higher than the given pressure. Here, it is assumed that the fragile portion 5 is a depressed part having a smaller thickness than the rest parts. As shown in FIG. 4, when internal pressure of the fuel cell case 3 becomes higher than the given pressure, a crack is first made between the fragile portion 5a and the fragile portion 5f (a portion shown by broken line P1), which is a center portion of line L1 connecting the fragile portions 5. Then, the crack spreads in the directions of arrow K1 and arrow K3, and further spreads in the directions of arrow K2 and arrow K4. As stated above, when internal pressure of the fuel cell case 3 becomes higher than the given pressure, a crack starts at the center portion of the line L1 connecting the fragile portions 5 and then spreads. Thus, the crack(s) on the line L1 becomes a single connected cutout.

In the case where the fragile portion 5 is a hole, the depressurizing opening 6 is also formed similarly to the case where the fragile portion 5 is the depressed part. This means that, when internal pressure of the fuel cell case 3 becomes higher than the given pressure, a crack is first made between the fragile portion 5a and the fragile portion 5f, connecting the fragile portion 5a and the fragile portion 5f with each other. Then, the crack spreads sequentially between the fragile portion 5a and the fragile portion 5b, between the fragile portion 5b and the fragile portion 5c, between the fragile portion 5c and the fragile portion 5d, and between the fragile portion 5d and the fragile portion 5e. Similarly, the crack also sequentially spreads between the fragile portion 5f and the fragile portion 5g, between the fragile portion 5g and the fragile portion 5h, between the fragile portion 5h and the fragile portion 5i, and between the fragile portion 5i and the fragile portion 5j. As stated above, when internal pressure of the fuel cell case 3 becomes higher than the given pressure, the crack(s) on the line L1 becomes a single connected cutout.

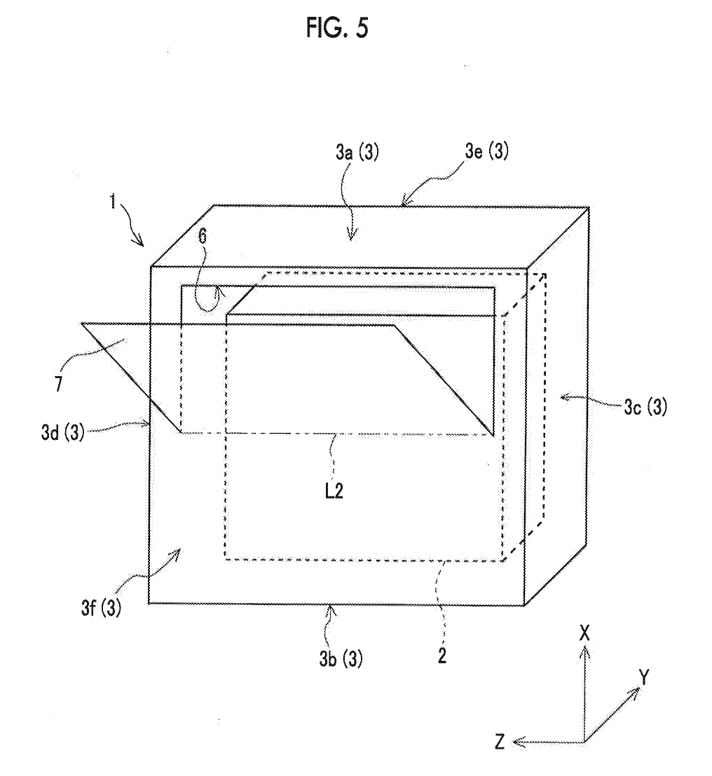

FIG. 5 is a schematic view of a state where the depressurizing opening 6 having the rectangular shape serving as the given shape is formed in the lower surface 3f that serves as the specific surface of the fuel cell case 3 shown in FIG. 3. As shown in FIG. 5, in the lower surface 3f serving as the specific surface, the crack(s) on the line L1 connecting the fragile portions 5 becomes a single connected cutout. Then, a broken piece 7 is folded to the outer side of the fuel cell case 3 along a two-dot chain line L2, and the depressurizing opening 6 having the rectangular shape serving as the given shape is formed in the lower surface 3f.

As described above, in this embodiment, in the specific surface of the fuel cell case 3, it is only necessary to provide the fragile portion 5 whose total area is much smaller than that of the depressurizing opening 6. Therefore, strength of the fuel cell case 3 does not decrease drastically. Thus, durability of the fuel cell case 3 against vibration and so on while a vehicle is running is not deteriorated. Further, when internal pressure of the fuel cell case 3 becomes higher than given pressure, a crack is made on a line connecting the fragile portions 5, and the crack(s) on the line becomes a single connected cutout. Because of this, the depressurizing opening having the given shape is formed on the specific surface of the fuel cell case 3, and it thus becomes possible to prevent an unintended portion from being broken due to hydrogen combustion when abnormality happens.

The disclosure is not limited to the foregoing embodiment, and changes may be made without departing from the gist of the disclosure.

In the foregoing embodiment, the surfaces of the fuel cell case, which are adjacent to the objects arranged outside the fuel cell case, are, but not limited to, the front surface, the rear surface, the right surface, and the lower surface. Depending on how each component is arranged under an engine hood of a vehicle, surfaces that are adjacent to objects arranged outside the fuel cell case change. Further, according to convenience for design, the specific surface, where the fragile portion is arranged, may be selected as appropriate from among the surfaces adjacent to the objects arranged outside the fuel cell case.

In the foregoing embodiment, the given shape of the depressurizing opening, which should be formed in the specific surface when internal pressure of the fuel cell case becomes higher than given pressure, is set to, but not limited to, the rectangular shape. The given shape of the depressurizing opening may be, for example, a triangle or a circle. As stated earlier, when the given shape of the depressurizing opening is the rectangular shape, the fragile portion is provided in the specific surface of the fuel cell case, for example, along the three sides of the rectangular shape. Similarly to this, when the given shape of the depressurizing opening is a triangle, the fragile portion is provided in the specific surface of the fuel cell case, for example, along two sides of the triangle. When the given shape of the depressurizing opening is a circle, the fragile portion is provided in the specific surface of the fuel cell case, for example, along a circular arc of the circle.

However, through the inventor's diligent research, it was found that, when the given shape of the depressurizing opening to be formed in the specific surface of the fuel cell case is the rectangular shape, and the fragile portion is provided along the three sides of the rectangular shape, a probability is higher that a crack is precisely made along the line that connects the fragile portion, and that the depressurizing opening is formed at a position and in a shape (the rectangular shape) as designed. Therefore, it is preferred that the given shape of the depressurizing opening to be formed in the specific surface of the fuel cell case is the rectangular shape, and that the fragile portion is provided along the three sides of the rectangular shape.

In the foregoing embodiment, the fragile portion is provided in the specific surface of the fuel cell case, so that the line connecting the fragile portion becomes a part of the outline of the given shape of the depressurizing opening to be formed. This means that, as described earlier, when the given shape of the depressurizing opening to be formed in the specific surface of the fuel cell case is the rectangular shape, the fragile portion is provided along the three sides of the rectangular shape. On the contrary, the fragile portion may be provided in the specific surface of the fuel cell case so that the line connecting the fragile portion becomes the entire circumference of the outline of the given shape of the depressurizing opening to be formed. This means that, when the given shape of the depressurizing opening to be formed on the specific surface of the fuel cell case is the rectangular shape, the fragile portion may be provided along all sides (four sides) of the rectangular shape. A fuel cell vehicle may be one without an engine. In this case, the engine hood is simply referred to as a hood.

However, it is more preferred that the fragile portion is provided in the specific surface of the fuel cell case, so that the line connecting the fragile portion becomes a part of the outline of the given shape of the depressurizing opening to be formed. This is because, when internal pressure of the fuel cell case becomes higher than given pressure and the depressurizing opening is formed, it is possible to prevent a broken piece from scattering.

What is claimed is:

1. A fuel cell system comprising:
a fuel cell that generates electric power by electrochemical reaction between hydrogen gas and oxidizing gas; and
a case that houses the fuel cell,
wherein a more fragile portion compared to a portion of the case other than the more fragile portion in terms of strength is provided in a specific surface of the case along an outline of a given shape so that a depressurizing opening having the given shape is formed when internal pressure of the case becomes higher than given pressure.

2. The fuel cell system according to claim 1, wherein
the specific surface is, among surfaces of the case, a surface adjacent to an object arranged outside the case.

3. The fuel cell system according to claim 1, wherein
the fragile portion is formed in the specific surface of the case along three sides of a rectangular shape so that the depressurizing opening having the rectangular shape is formed when internal pressure of the case becomes higher than the given pressure.

4. An under hood structure of a vehicle, comprising:
a fuel cell that generates electric power by electrochemical reaction between hydrogen gas and oxidizing gas;
a case that houses the fuel cell; and
an object that is arranged outside the case and adjacent to a specific surface of the case,
wherein a more fragile portion compared to a portion of the case other than the more fragile portion in terms of strength is provided in the specific surface of the case along an outline of a given shape so that a depressurizing opening having the given shape is formed when internal pressure of the case becomes higher than given pressure.
